(19) United States
(12) Patent Application Publication
(10) Pub. No.: US 2025/0035030 A1
(43) Pub. Date: Jan. 30, 2025

(54) METHOD FOR PRODUCING AN INTERNAL COMBUSTION ENGINE COMPRISING A PRECOMBUSTION CHAMBER

(71) Applicant: Liebherr Machines Bulle SA, Bulle (CH)

(72) Inventors: Olivier FRANGNIÈRE, Courtaman (CH); Fabio RICCA, Pully (CH)

(21) Appl. No.: 18/784,318

(22) Filed: Jul. 25, 2024

(30) Foreign Application Priority Data
Jul. 28, 2023 (CH) CH000821/2023

(51) Int. Cl. F02B 19/12; F02B 19/18

(52) U.S. Cl. CPC F02B 19/12; F02B 19/18

(57) ABSTRACT

The disclosure relates to a method for producing an internal combustion engine, in particular a gas engine, comprising a precombustion chamber and an ignition device that protrudes into the precombustion chamber, and a precombustion chamber injector that supplies fuel to the precombustion chamber, characterized in that a precombustion chamber module having an integral cavity, forming the precombustion chamber, is manufactured as a separate component from the cylinder head, wherein the precombustion chamber module comprises, in addition to the cavity forming the precombustion chamber volume, at least one transfer port for the fluidic connection between the precombustion chamber and main combustion chamber, and the precombustion chamber module is produced as a whole or at least in part by means of an additive method, in particular by 3D printing.

### CROSS REFERENCE TO RELATED APPLICATION

The present application claims priority to Swiss Patent Application No. 000821/2023 filed on Jul. 28, 2023. The entire contents of the above-listed application are hereby incorporated by reference for all purposes.

### TECHNICAL FIELD

The disclosure relates to a method for producing an internal combustion engine, in particular a gas engine, comprising a precombustion chamber and an ignition device that protrudes into the precombustion chamber, and a precombustion chamber injector that supplies fuel to the precombustion chamber.

### BACKGROUND

Combustion chamber units having an active precombustion chamber are already known in three different expansion stages. The first known and most widespread variant-referred to in the following as Design I-relates to an active precombustion chamber which merely performs the function of an ignition amplifier. A second variant corresponds to a combustion chamber unit, into the main combustion chamber of which fuel can be supplied merely via one single path extending via the active precombustion chamber. This variant is referred to hereinafter as Design II. In addition, combustion chamber units having an active precombustion chamber are known which selectively allow for fuel supply via the active precombustion chamber or alternatively via a second fuel path, for example by means of intake manifold injection. A corresponding embodiment, in which, due to the construction, the main injection for covering the fuel requirement necessary in the main combustion chamber can take place fully along the fuel path extending over the precombustion chamber only within a certain sub-region of the engine operating range, will be referred to in the following as Design IIIa. A corresponding embodiment, in which, despite the presence of a fuel path extending via the suction intake, the fuel path extending via the precombustion chamber is designed correspondingly, such that the internal combustion engine can take place exclusively via the precombustion chamber, within its entire speed/torque working range, is referred to in the following as Design IIIb.

### SUMMARY

Purely conceptually, i.e., from a schematic perspective, the implementation of this design appears to be very simple. In fact, the structural implementation for current engines, with their correspondingly high power density, is non-trivial. A correspondingly sufficient amount of energy emanating from the primary ignition unit must always spread in the precombustion chamber in a functional manner and thus reproducibly, specifically in order to ensure that the ignition process of the fuel/air mixture located inside the precombustion chamber takes place reliably and can be reproduced according to the demands. Furthermore, the precombustion chamber must be positioned in such a way that the ignition torches, overshooting into the main combustion chamber and still burning or already extinguished, but still having high thermal energy, due to the ignition process taking place inside the precombustion chamber, spread in in the main combustion chamber a coordinated manner, i.e. in a synchronous manner, as it were. Only in this way does a uniform spread of the flame front occur within the main combustion chamber.

An engine design is already known from US2017/122184 A1 which provides for an active precombustion chamber. The combustion chamber unit provided with an active precombustion chamber is intended to be configured such that a supply of fuel, to be performed purposely, into the main combustion chamber can take place via the injector that introduces fuel into the precombustion chamber. However, the teaching of US2017/122184 A1 lacks a specific example as to how the integration of an active precombustion chamber of this kind into a usable internal combustion engine can actually be implemented.

On account of generally known requirements and particular advantages, internal combustion engines today have a high power density, specifically both with respect to the overall engine displacement volume and with regard to the power density based on the external dimensions of an internal combustion engine, and also with respect to the weight-related power density. Furthermore, on account of certain advantages, current internal combustion engines have not individual intake/exhaust valves but rather pairs thereof. Quasi eponymously, in the case of spark-ignited internal combustion engine it is necessary to introduce the ignition energy. In the case of a precombustion chamber engine, the external, i.e., primary, ignition energy must clearly be introduced into the precombustion chamber, as a result of which particular functional elements of the primary ignition device must be located inside the precombustion chamber or in the direct vicinity of the precombustion chamber.

Furthermore, an active precombustion chamber must have its own fuel supply path, which makes the integration yet more demanding. If the engine design provides that the main injection into the main combustion chamber should take place within the entire speed/torque operating range or at least a certain sub-region thereof, via the fuel path extending via the precombustion chamber, then the integration of a corresponding functional and reliable active precombustion chamber of this kind, due to the use of which the conceptually identifiable potential advantages actually come to bear in a usable product, is not limited to a simple component integration, but rather instead requires significant development effort. This relates to the arrangement and shaping of the geometry features of the precombustion chamber and the transfer ports, as well as the specific implementation of the respective supplies of the fuel and the primary ignition energy into the active precombustion chamber.

The availability of corresponding combustion chamber units allows for production of fully operational corresponding precombustion chamber engines, while maintaining the pre-existing short engine configuration. It is desirable for the relevant difference between a stock engine and a precombustion chamber engine derived therefrom is so small that there is complete identity of the interfaces (see below) between a pre-existing internal combustion engine and an internal combustion engine according to the disclosure that is derived therefrom; at least provided that the latter has its basic configuration.

The term “interfaces” is intended to include the following, for example:
mechanical connections for fixing the internal combustion engine and those components and devices attached to the basic engine, relating to the fixing and torque transfer
connections to the internal combustion engine for inflowing and outflowing fluids, e.g., air, exhaust gas, fuel, lubricants, and coolants, etc.

This achieves that
the developing work for an internal combustion engine according to the disclosure is as minimal as possible, provided a corresponding stock engine already exists or even if one such is already industrialized.
the integration of the resulting internal combustion engine into a superordinate system (e.g., a mobile work machine, a road vehicle or in a stationary system) requires the least possible effort, provided that a corresponding stock engine is already used in such a system, or such corresponding development progress exists for achieving this aim.

Ideally, achieving the above-mentioned aims should even allow for conversion of a stock engine that is already being used as intended.

In the case of a new engine construction to be performed, said engine should, based on a comparable internal combustion engine that meets current standards, have the same characteristic volume ratio between (i) the overall engine displacement and (ii) approximately the same or preferably smaller outside dimensions with respect to the engine block. According thereto, in particular the distance between in each case two combustion chambers that are located on the same cylinder bank and are in this case directly adjacent, must, according to current standards, be small, and equally the power density of each combustion chamber must be correspondingly high. Consequently, in each case merely comparatively small cross-sectional areas are available, over which the actually functional fuel supply path and the ignition path have to be moved towards the relevant precombustion chamber.

The present disclosure relates to the construction or modification of a combustion chamber unit which, in addition to the current standard functions, which can be achieved by such components corresponding to the prior art, comprises an active precombustion chamber. The integration of the active precombustion chamber should be implemented in such a way that it is possible to draw on a pre-existing structure of an internal combustion engine for the structure of a fully functional internal combustion engine, and the modifications necessary in this case are very largely limited to such measures that are directly due to the fact that it is an internal combustion engine which consists of such combustion chamber units that each comprise active precombustion chambers.

This object is achieved by a method for producing an internal combustion engine comprising a precombustion chamber. The disclosure is furthermore achieved by an internal combustion engine which is produced according to the method according to the disclosure.

According to the disclosure, the internal combustion engine is manufactured having a precombustion chamber module which is produced as a separate component from the cylinder head. The precombustion chamber module comprises the cavity that forms the precombustion chamber, as a result of which a defined precombustion chamber volume is present above the precombustion chamber module incorporated in the cylinder head. In this case, it is proposed for the precombustion chamber module, comprising the cavity forming the precombustion chamber volume and at least one transfer port for the fluidic connection between the precombustion chamber and main combustion chamber to be produced by 3D printing methods or by means of another additive method. Since the geometric configuration of the precombustion chamber volume is typically subject to high demands with regard to dimensional compliance and surface quality, a manufacturing method is used for said component, the use of which makes it possible to meet these high demands. These exist not only with respect to the configuration of the precombustion chamber volume, i.e. that of the cavity, but rather also for the embodiment of possible transfer ports which are introduced in a corresponding wall of the precombustion chamber module and which, following installation of the precombustion chamber module, constitute the connection between the cavity forming the precombustion chamber and the relevant main combustion chamber. The configuration and channel guidance of such transfer ports is also decisive for the functional interaction of the precombustion chamber and the main combustion chamber.

According to an advantageous embodiment of the disclosure, it can be provided that the precombustion chamber module also serves as a support for receiving the precombustion chamber injector and/or an ignition device, for example in the embodiment of a spark plug for igniting the air/fuel mixture within the precombustion chamber. This for example allows for production and assembly of an internal combustion engine, in that the precombustion chamber module is prefabricated and is equipped with the precombustion chamber injector and/or the ignition device prior to installation into the cylinder head. The fully equipped precombustion chamber module can then be inserted as a compact unit into the cylinder head of the internal combustion engine. As a result, the installation of the ignition device and of the precombustion chamber injector is simplified since this can take place outside of the cylinder head. The proposed procedure also allows for a functional test before the module is installed in the cylinder head.

It can be provided that the precombustion chamber injector does not lead directly into the cavity of the precombustion chamber module, but rather instead the relevant fluid connection between the outlet of the precombustion chamber injector to the cavity corresponding to the precombustion chamber exists via a connecting channel present in the precombustion chamber module. In the simplest case, the connecting channel can be configured cylindrically over the entire length. However, an embodiment having a profile shape that changes in the longitudinal direction is also conceivable. Ideally, the connecting channel is configured having at least one conical portion, in particular having a channel diameter that reduces in the direction of the cavity. Such an embodiment of the connecting channel can effectively prevent or minimize the occurrence of the undesired effect of backfiring from the precombustion chamber in the direction of the precombustion chamber injector.

It is also advantageous if the channel shape is configured or is provided with suitable guide elements such that turbulence of the fuel injected into the cavity is actively produced or promoted. Turbulence in the intake region of the precombustion chamber improves the mixing of the injected fuel with the air mixture contained in the precombustion chamber. The connecting channel can have a straight course, but manufacture having a course that is curved or angled in portions is also conceivable, wherein the trajectory over which the curvature extends is preferably located in one plane. This can also promote improved homogeneity of the fuel/air mixture within the precombustion chamber. Manufacture of the connecting channel having a helical channel progression at least in portions is also conceivable. The helical or coil-like channel guidance automatically produces or amplifies turbulence of the fuel entering the cavity. A quarter or a half of a complete coil shape may be sufficient. In particular owing to manufacture by 3D printing or by means of another additive method, the channel shape of the connecting channel can be optimized with particularly suitable use being made of the above-mentioned aspects, in order to promote optimal mixing of the fuel currently supplied into the precombustion chamber in each case, with the air located therein or the gas mixture already located therein.

According to an advantageous embodiment of the disclosure, it is proposed to manufacture the precombustion chamber module in two or in multiple parts. A first component of the precombustion chamber module, comprising the cavity forming the precombustion chamber volume and the at least one transfer port, is preferably produced by means of 3D printing or an additive method, while at least one further component, which is part of the precombustion chamber module, is produced by means of a method deviating therefrom. These at least two components are assembled in a downstream step. Since the geometric configuration of the precombustion chamber volume and the at least one transfer port is typically subject to high demands with regard to dimensional compliance and surface quality, the first component is created by means of 3D printing. A further component of the precombustion chamber module, which comprises neither said cavity nor one of the transfer ports, can instead be produced using a deviating manufacturing method, since the further components of the precombustion chamber module are subject to lower demands with regard to dimensional unit and surface quality. Therefore, for economic reasons, recourse to a more cost-effective production method for these further components may be expedient. For example, conventional subtractive manufacturing methods are conceivable. The multipart configuration of the precombustion chamber module furthermore has the advantage that individual components of said module, which are subject to relatively high wear, can be exchanged separately. For example, the transfer ports and also the cavity are subject to high wear, and therefore the above-mentioned first component can already be exchanged preventatively, in the course of maintenance required elsewhere, if required or in the context of maintenance or repair that is primarily required elsewhere.

In order to achieve a highly functioning high-quality product, the above-mentioned connecting channel can also be subject to high demands with regard to dimensional compliance and surface quality, such that it is expedient in this connection if the part of the precombustion chamber module that comprises the connecting channel is also manufactured by means of an additive method, in particular by 3D printing. This is all the more the case if the connecting channel, in a functionally particularly advantageous embodiment, has a special channel guidance, for example if a course is present which is angled or curved ad/or coil-shaped at least in portions, and/or is also provided, at least in portions, with a channel contour that is conical with respect to the longitudinal direction. In particular, the connecting channel is integrated into the first component, which, in addition to the cavity forming the precombustion chamber, also comprises the at least one transfer port.

Preferably, those further components of the precombustion chamber module which merely have a supporting or fixing function, can be manufactured by means of a deviating manufacturing method. For example, such further components comprise the necessary receiving drilled holes for insertion of the precombustion chamber injector and/or the ignition device. The receptacles to be manufactured allow for greater manufacturing tolerances, and therefore such components of the precombustion chamber module can be manufactured by means of subtractive production methods. This applies similarly for components or sub-regions of the precombustion chamber module which comprise contact surfaces and fixing means for mounting and fastening the precombustion chamber module to the cylinder head.

Irrespective of whether the precombustion chamber module is configured in one piece or in multiple parts, the production of the precombustion chamber module requires use of 3D printing. The use of a combined 3D printing method is also expedient, which method provides for use of different 3D printing methods in the production. For example, the 3D printing methods may differ with respect to the set machine parameters of the 3D printing system and/or with respect to the materials used for it. It is also conceivable that, in the case of the combined 3D printing method, different sub-regions of the precombustion chamber module are created by means of different 3D printing methods. It is also possible, however, for a single sub-region to be created by means of different 3D printing methods, in that the 3D printing methods are performed in temporal succession and/or using two or more separate devices, via which the respective materials are applied. For example, a 3D printing method can be varied by means of a specific configuration (the application material used, the proportional composition of the application material, the set machine parameters, etc.) with regard to the printing speed, the material costs or the precision, etc. It is conceivable, for example, to first work using a high-speed printing 3D printing method, which allows for a quick and/or cost-effective volume building. Subsequently or in the interim, in order to comply with the respectively higher specific requirements, finishing work is possible using a 3D printing method that is slower and/or more cost intensive for another reason, the use of which makes it possible to achieve for example greater precision of the dimensional compliance or a higher surface quality.

It is also conceivable for a hybrid method to be used, irrespective of a one-piece or multiple-part configuration of the precombustion chamber module, which hybrid method uses, in addition to a 3D printing method, at least one alternative production method, for example a productive production method, for example polishing or lapping. As already indicated above, different sub-regions of the precombustion chamber module can be produced by means of various different methods, which can achieve advantages such as a reduction in the production costs and/or a targeted product quality that is differentiated based on the existing product requirements. It is also conceivable, however, for an identical sub-region to be processed by means of different methods, in at least two steps. For example, first, by means of a subtractive method, a certain part of a component can be manufactured, whereas with respect to the finished component other sub-regions are created by means of 3D printing methods, because complete production exclusively using, since for example on the one hand production only using subtractive methods is not possible at all, while complete production exclusively using one of the combination of a plurality of 3D printing methods would result in significantly higher costs. The sub-region that is finished using a 3D printing methods is preferably the region that is subject to the highest demands with regard to dimensional accuracy and/or surface quality. An advantage of this method is that the sealing between the sub-regions, of which the precombustion chamber module is made up, already results by nature after finishing, and does not have to be brought about first by a scaling system.

It may be expedient if, during processing of a sub-region of the precombustion chamber module by means of combined 3D printing and/or by means of a hybrid method, a buffer layer is applied, in order to achieve improved binding between the layers. A buffer layer of this kind is preferably also applied by 3D printing methods. It may be advantageous, for example, for a buffer layer to be applied at least in regions and preferably by means of 3D printing, in a subsequent step, to an existing component blank of the precombustion chamber module, which has been produced by means of another production method, for example by means of a subtractive method, before the manufacturing continues, in a downstream step, by means of 3D printing. The 3D printing is then performed at least in part on this buffer layer. It is also conceivable to apply a buffer layer at least in regions on a component blank of the precombustion chamber module, which was produced at least in part using 3D printing. Subsequently, further volumes can then be applied by means of 3D printing, preferably by means of a deviating 3D printing method, at least to the sub-region provided with the buffer layer. As a precaution, it is pointed out that the application of the buffer layer results in virtually no volume increase on the precombustion chamber module; the sole purpose of the buffer layer is to achieve improved binding between the layers.

Ideally, the precombustion chamber module comprises a first component which, in addition to the cavity forming the precombustion chamber and the transfer ports, also comprises the connecting channel. In contrast, at least one further component of the precombustion chamber module comprises the majority of the portion that surrounds the recesses for receiving the precombustion chamber injector and the ignition device.

As has already been set out in the introductory part, it is desirable to have available a standard engine block which can be selectively equipped with the suitable precombustion chamber module, in order to allow, based thereon in each case, the construction of an internal combustion engine that is constructed, and accordingly used, according to one of the presented Designs I, II, IIIa and IIIb. Ideally, a standard cylinder head should also be available for these different designs, which, according to the disclosure, can be achieved by an advantageous construction of the precombustion chamber module having an intelligent arrangement of the components of precombustion chamber injector and ignition device. In particular the operation according to Designs II and IIIa, IIIb requires a comparatively large-volume fuel injector for the fuel supply into the precombustion chamber, in order to allow, at all, for direct injection into the main combustion chamber via the precombustion chamber for as large as possible an operating range of the internal combustion engine, up to the engine operating point of maximum fuel consumption. However, this requires an arrangement and orientation of the two components of precombustion chamber injector and ignition device for the precombustion chamber that differs from that known from the prior art.

Against this background, it is proposed to manufacture the precombustion chamber module having receiving drilled holes for receiving the ignition device and the precombustion chamber injector, the longitudinal axes of which do not extend in parallel with one another, but rather of which the imaginary continuations of the longitudinal axes instead intersect. In other words, the orientation of the insertable ignition device and of the precombustion chamber injector extend obliquely to one another, such that the available installation space above the main combustion chamber can be utilized in an ideal a manner as possible. This allows for use of large-volume precombustion chamber injectors or use of such precombustion chamber injectors that have a comparatively large diameter. In the following, for the sake of simplicity, reference will be made simply to longitudinal axes, but it is of course self-evident that the following statements also mean the imaginary continuations of the longitudinal axes.

In this connection, it is preferred for the longitudinal axis of one of the components of precombustion chamber injector and ignition device to extend in parallel with, preferably congruently with, an imaginary longitudinal axis of the main combustion chamber, in the installed state.

It is particularly preferable if the precombustion chamber module is manufactured having a longitudinal axis of the cavity forming the precombustion chamber that extends in parallel with, in particular congruently with, the longitudinal axis of the receiving drilled hole for receiving the ignition device. It is proposed in particular for the precombustion chamber module to be manufactured having a receiving drilled hole for the ignition device, the longitudinal axis of which extends obliquely to a main axis or longitudinal axis of the main combustion chamber. Accordingly, a longitudinal axis of the cavity is also oriented obliquely to the longitudinal axis of the main combustion chamber.

In this connection, it is particularly preferable for the internal combustion engine to be manufactured having a standard cylinder head, which can be equipped selectively with a specific precombustion chamber module in each case, depending on the desired fuel supply design, i.e. a design according to I, II, III, IIIa, IIIb. Accordingly, a suitable internal combustion engine for the desired fuel supply design can be constructed only by adapting the precombustion chamber module, in particular adapting the receiving drilled hole for the precombustion chamber injector and the installation of the precombustion chamber injector required for the respective design, as well as the geometric configuration of the precombustion chamber volume. Ideally, the short engine comprising the engine block, the crank drive, the valve drive, etc. can be retained unchanged. Further changes to the peripheral equipment are not essentially required, but may be expedient for achieving additional value, for example a change to the air gap or to the fuel path, in order to allow for the corresponding fuels to be supplied under a higher pressure level.

On account of the occurring temperatures in the region of the precombustion chamber, cooling of the precombustion chamber module is necessary or at least advantageous. The course of possible cooling channels extending in the cylinder head is preferably adapted to the structure of the precombustion chamber module, as a result of which these flow around the inserted module. Ideally, coolant flows directly around the wall of precombustion chamber module. It is advantageous if the precombustion chamber module is printed having such an outside wall which is provided with one or more ribs, for the purpose of enlarging the surface and increasing the achievable cooling effect. The presence of a correspondingly purposely selected specific wall contour makes it possible to achieve such turbulence of the cooling medium flowing past, in which the cooling effect of the wall region surrounding the precombustion chamber can be further amplified. In the case of multi-part manufacture of the precombustion chamber module, corresponding ribs, configured in a manner optimized to this effect, are preferably created on the outside wall of the first component during production thereof by an additive method, for which purpose an additive production method, in particular 3D printing, is used.

Furthermore, it may be expedient for the precombustion chamber module to be printed having cavity, forming the precombustion chamber, that does not have a rotationally symmetrical geometry, but rather instead the cavity the precombustion chamber module is created having one or more partial widenings that enlarge the volume. A widening configured in this way can be bead-like. Corresponding partial widenings are preferably present in or around the mouth region of the precombustion chamber injector or of the relevant connecting channel. With the aid of the partial widening, better mixing of the entering fuel with the air already located in the cavity can be achieved, which in each case comes into play advantageously within those operating phases in which the fuel loading of the precombustion chamber takes place which is used for the later formation of the ignition torches. The partial widening is preferably configured such that there is precisely one imaginary plane positioned in this way, by which the cavity forming the precombustion chamber can be notionally divided into two regions, which each have the same geometry.

In addition to the method according to the disclosure, additionally an internal combustion engine, in particular a gas engine, particularly preferably a hydrogen engine, is proposed, which is produced according to the method according to the disclosure, the precombustion chamber of which, implemented by means of the precombustion chamber module, serves purely as an ignition amplifier. The internal combustion engine can furthermore additionally comprise intake manifold injection, which, in one of the possible embodiments, is the only fuel supply path for the main combustion chamber, while the precombustion chamber functions merely as an ignition amplifier. It is preferable for the relevant fuel output out of the injector for the intake manifold injection to open in the portion of the suction duct which is already incorporated in the cylinder head. The injector for the intake manifold injection can then preferably be fastened indirectly or preferably directly on the cylinder head.

In addition, according to the disclosure an internal combustion engine, in particular a gas engine, particularly preferably a hydrogen engine, is proposed, which is also produced according to the method according to the disclosure, the precombustion chamber injector of which, however, is configured for supplying fuel into a main combustion chamber via the precombustion chamber. In particular, the fuel injector is configured such that it is possible, without using a fuel path in parallel therewith, to cover the amount of fuel that can be supplied, for a particular partial load operation, up to the extent that even the engine operating point of maximum fuel consumption is sufficient exclusively via the fuel path extending via the precombustion chamber. The internal combustion engine can additionally comprise intake manifold injection, which serves as one of the possible fuel supply paths into the main combustion chamber. It is preferable for the relevant fuel discharge mouth, i.e., the injector for the intake manifold injection, to open in the portion of the suction duct which is already incorporated in the cylinder head. The injector for the intake manifold injection can then preferably be fastened indirectly or preferably directly on the cylinder head.

Further advantages and properties of the disclosure will be explained in greater detail in the following, with reference to an embodiment shown in the figures, in which:

### BRIEF DESCRIPTION OF THE FIGURES

FIG. 1: is a cross-section through the cylinder head of a first embodiment of the internal combustion engine according to the disclosure, having an inserted precombustion chamber module,

FIG. 2: is a detailed view of the cylinder head according to FIG. 1 in the region of the cavity that forms the precombustion chamber,

FIG. 3a, 3b: are perspective views of the non-equipped cylinder head according to the first embodiment,

FIG. 4: is a plan view of the non-equipped cylinder head according to the first embodiment,

FIG. 5: is a perspective view of the fully equipped cylinder head according to the first embodiment,

FIG. 6: is an exploded view of the cylinder head together with the precombustion chamber module, according to the first embodiment,

FIG. 7a, 7b: show different variants of the precombustion chamber module,

FIG. 7c: is a sectional view of the precombustion chamber module,

FIGS. 8a-8c: are detailed views of the precombustion chamber module,

FIG. 9: is a schematic view of the flame plate of the cylinder head, viewed from a perspective from the combustion chamber,

FIG. 10a, 10b: show a multipart embodiment of the precombustion chamber module,

FIG. 11a, 11b: are sectional views through the cylinder head according to the disclosure of the internal combustion engine according to the first embodiment, with two different variants of a mounted cylinder head cover, and

FIG. 12: shows a further alternative embodiment of the precombustion chamber module.

### DETAILED DESCRIPTION

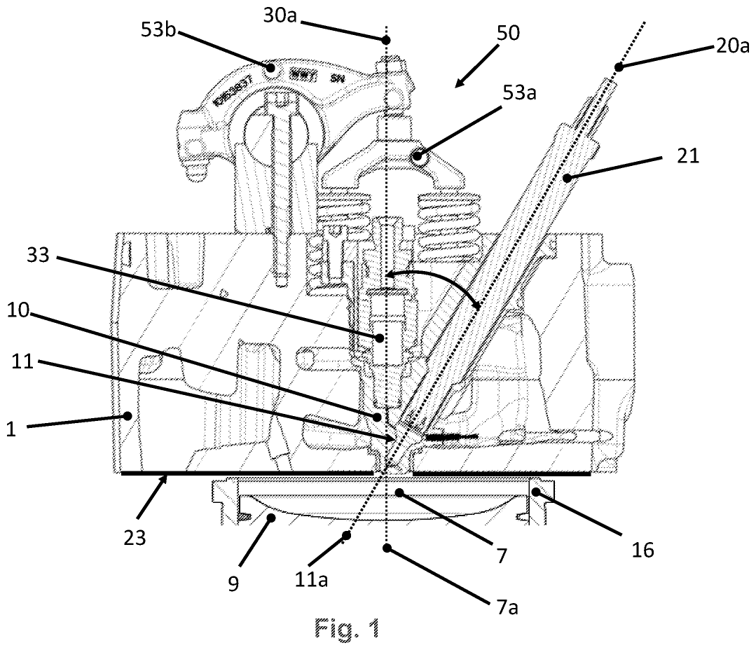

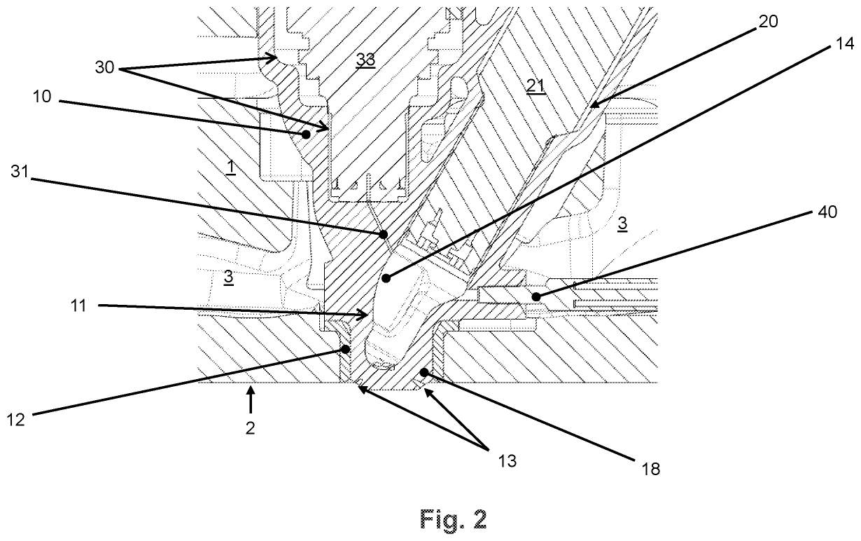

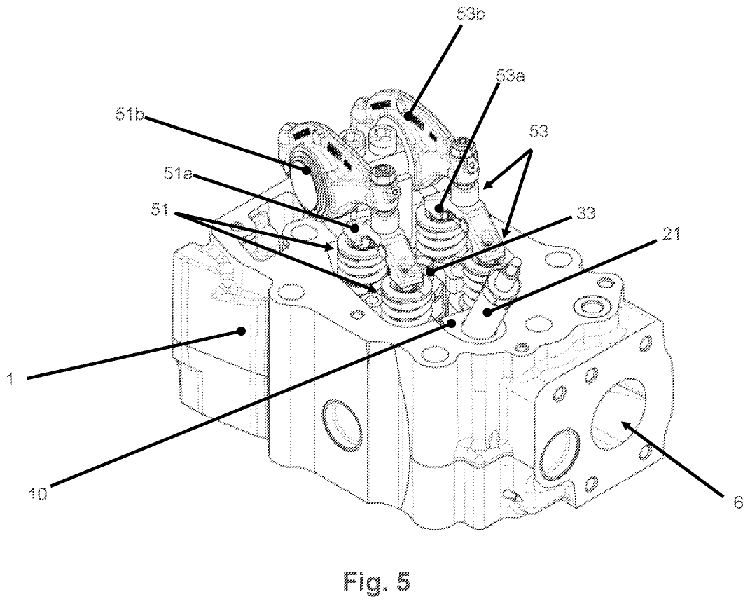

FIG. 1 is a cross-section through the cylinder head 1 of an internal combustion engine according to the disclosure, which is preferably configured as a gas engine, in particular as a hydrogen engine, and is constructed with the aid of a precombustion chamber module 10 which can be produced by means of the method according to the disclosure. FIG. 2-5 are alternative perspective or detailed views of this embodiment. Reference sign 2 denotes the region of the flame plate 2 of the cylinder head 1. On the top of the cylinder head 1, the valve drives 50 for the intake and exhaust valves are installed above the respective main combustion chambers. In the case of the internal combustion engine shown here, there is a pair of intake and exhaust valves 53, 51 per combustion chamber, which can each be actuated via a common valve bridge 51a, 53a and the common rocker lever 51b, 53b (see FIG. 5, 6). Below the valve drive 50, the precombustion chamber module 10 is inserted into a recess 4 of the cylinder head 1 provided for it.

The precombustion chamber module 10 serves as a support for a spark plug 21, and a precombustion chamber injector 33. For this purpose, the spark plug 21 is inserted into a corresponding receiving drilled hole 20 of the precombustion chamber module 10, the stepped receiving drilled hole 30 serves for insertion of the precombustion chamber injector 33. The longitudinal axis 30a of the receiving drilled hole 30 or of the inserted precombustion chamber injector 33 extends flush or congruently with the longitudinal or rotational axis of the main combustion chamber 7 located therebelow. Relating to the piston 9 and the liner 16, the selected longitudinal section shows only the vicinity of the combustion bowl. The cylinder head seal is denoted by reference sign 23. The longitudinal axis 20a of the receiving drilled hole 20 or the inserted spark plug 21 extends obliquely to the axis 30a or to the combustion chamber axis 7a. The cavity forming the combustion chamber volume of the precombustion chamber is denoted by reference sign 11. It can be seen that the longitudinal axis 11a of the cavity 11, i.e. the precombustion chamber, is located on the longitudinal axis 20a of the ignition device, and thus is also oriented obliquely to the longitudinal axis 7a of the main combustion chamber 7 and the longitudinal axis 30a of the precombustion chamber injector 33.

As a result of this measure, the available installation space under the valve drive 50 can be utilized almost entirely for the installation of a precombustion chamber injector 33, as a result of which this can be dimensioned to be significantly larger, and the maximum amount of fuel that can be supplied by means of the precombustion chamber injector 33 per cycle—or within a time corridor available therein—increases significantly. The proposed construction thus allows for an engine operating design according to the variants I, II, IIIa and IIIb mentioned at the outset.

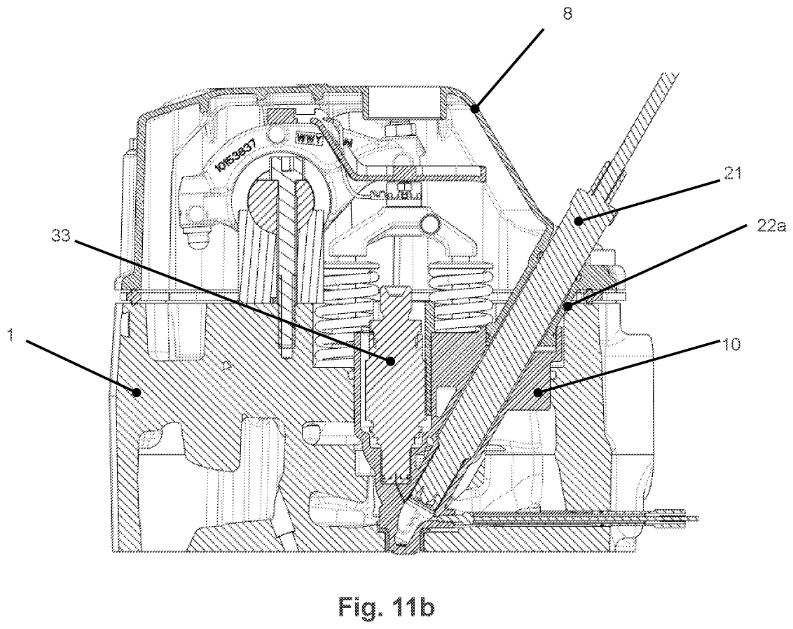

A further advantage of this construction is that, due to the oblique positioning, the end of the spark plug 21 does not emerge from the cylinder head in the region of the valve drive 50, but rather moves relative thereto in the direction of the air intake. Thus, the exposed end of the spark plug 21 is freely accessible. Ideally, the tilt angle of the longitudinal axis 20a is selected in such a way that the spark plug 21 does not protrude out of the cylinder head 1 under the cylinder head cover 8 that is placed on, but rather also protrudes in a manner offset laterally in the direction of the air intake (see FIG. 11a, 11b), such that the spark plug 21 can be exchanged accessibly and conveniently, without dismantling the cylinder head cover 8 or other components of the cylinder head 1. For stabilizing and fixing the spark plug 21, for this purpose a guide sleeve 22 that lengthens the receiving drilled hole 20 is inserted into said hole, which sleeve is fixed to the precombustion chamber module 10 on one side and to the edge of the cylinder head cover 8 on the other side (see FIG. 11a). Alternatively, the guide sleeve 22a could also be formed entirely by the cylinder head cover 8 (FIG. 11b), wherein in this case manufacture of the cylinder head cover 8 by means of 3D printing or another additive production method is expedient.

An enlarged detailed view of the precombustion chamber module 10, in particular of the region around the cavity 11, is shown in FIG. 2. This embodiment of the precombustion chamber module 10, shown enlarged here, shows a cavity 11, forming the precombustion chamber, which is not rotationally symmetrical, but rather instead has a geometry that varies over its periphery. In particular, in this case, a partial widening 14 of the cavity 11, enlarging the diameter, is provided in the region under the fuel supply opening of the connecting channel 31, which is associated, as a result, with a general widening of the corresponding local outside dimensions. This widening makes it possible for turbulence of the entering fuel to be created in a targeted manner, and thus improved mixing with the air mixture contained inside the precombustion chamber to be achieved. The precombustion chamber injector 33 is fluidically connected to the cavity 11, via the connecting channel 31 integrated into the module, for the purpose of the supply of fuel into the precombustion chamber. In the embodiment shown here, the connecting channel 31 has a straight course, wherein in the simplest case this can be configured to be cylindrical. However, a channel configuration which is conical at least in portions is preferable, wherein the channel diameter preferably reduces in the direction of the cavity 11. This measure makes it possible for undesired backfiring from the precombustion chamber in the direction of the precombustion chamber injector 33 to be reduced or prevented.

The lower dome 18 of the precombustion chamber module 10 protrudes out of the flame plate 2 of the cylinder head 1 and ends in the main combustion chamber 7. The dome 18 comprises a plurality of transfer ports 13, which form the necessary fluidic connection between the precombustion chamber and the main combustion chamber 7. Said transfer ports 13 allow both for the through-flow of fuel from the precombustion chamber into the main combustion chamber 7, quasi a direct injection, and also overshooting of the ignition torches from the precombustion chamber into the main combustion chamber 7. These transfer ports 13 also serve to supply air into the precombustion chamber. A flange ring 12 extends around the outer periphery of the dome 18 of the precombustion chamber module 10, in order to seal the main combustion chamber 7 in the inlet region of the cap 18 of the precombustion chamber module 10.

Furthermore, sub-portions of the cooling channels 3 extending in the cylinder head 1 can be seen in the cross-sectional view. The course of the cooling channels 3 was adjusted such that the circulating cooling medium flows directly around the inserted precombustion chamber module 10, in particular in the wall region of the cavity 11.

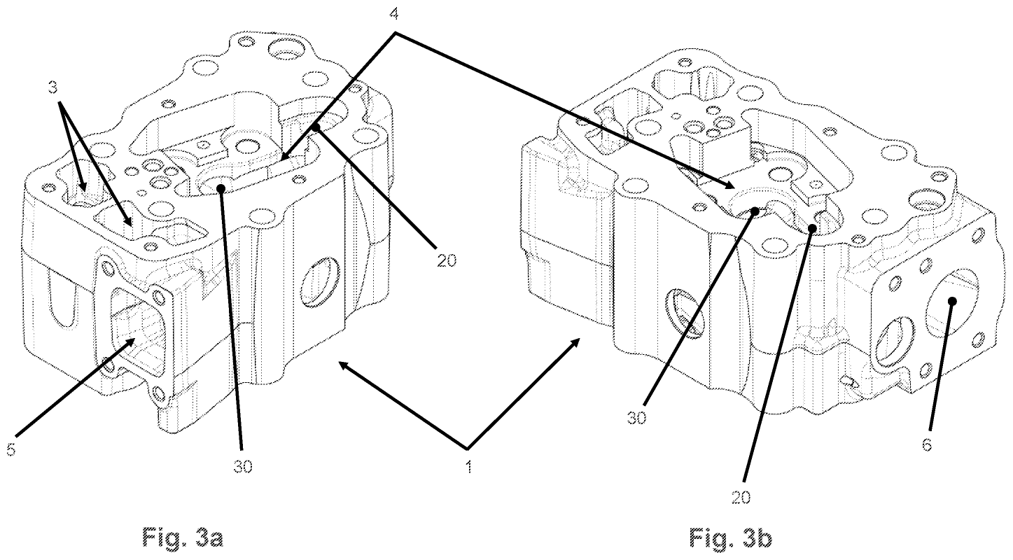

FIG. 3a, 3b are perspective views of the non-equipped cylinder head 1 comprising the corresponding recess 4 for the insertion of the precombustion chamber module 10. The recess 4 also serves for installation of the valve lifter for the intake and exhaust valves 53, 51. It can be seen in this illustration that the receiving drilled hole 20 for the spark plug 21 protrudes obliquely into the cylinder head 1, in the vicinity of the air intake 6. The opening of the exhaust gas outlet 5 is located on the side of the cylinder head 1 opposite the air intake 6.

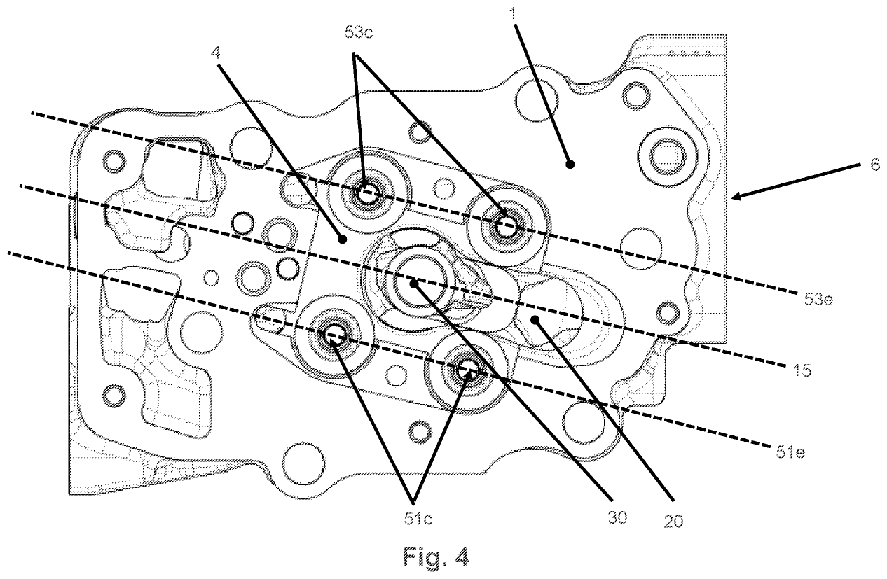

FIG. 4 is a plan view of the cylinder head 1 and is intended to illustrate the position of the precombustion chamber module 10 relative to the valve drive 50. The recess 4 comprising the drilled holes 20, 30 and the drilled holes 53c for receiving the valve lifters of the intake valve 53, and the corresponding drilled holes 51c relating to the exhaust valves 51 are visible. The dashed line 53e corresponds to the plane spanned by the respective imaginary center axis of the two intake valves 53 or the corresponding valve lifters 55a, the dashed plane 51e represents the plane spanned by the respective imaginary center axis of the two exhaust valves 51 or the corresponding valve lifters 55b. The spanned plane 15 corresponds to the plane spanned by the longitudinal axes 30a, 20a of the precombustion chamber injector 33 and of the spark plug 21. It can be seen that the latter plane 15 is located in parallel between the two planes 51c, 53c, in particular centrally between the two planes 51e, 53c. FIG. 5 shows the fully equipped cylinder head having the valve drive 50 and the inserted precombustion chamber module 10.

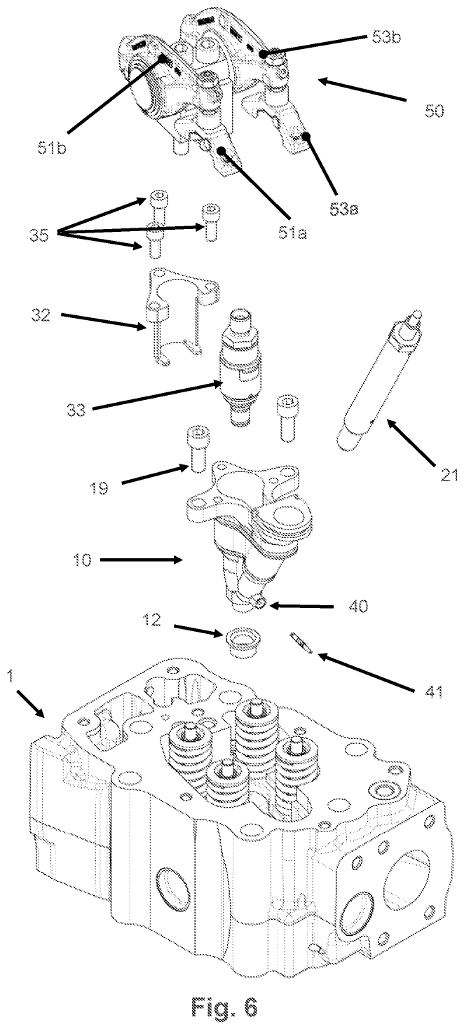

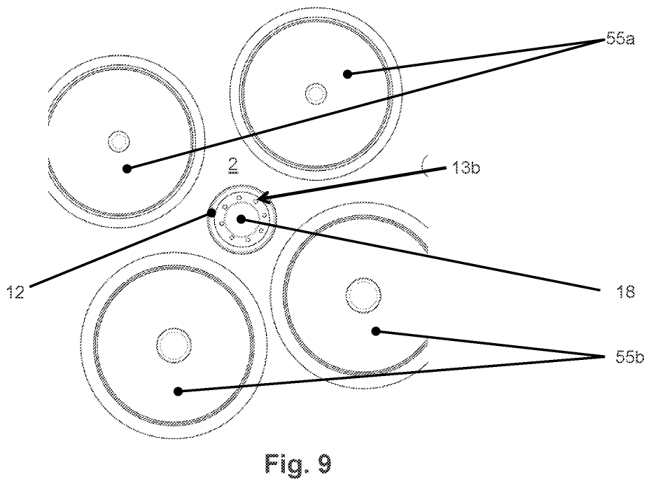

FIG. 6 is an exploded view of a number of components, in focus here, in the vicinity of the cylinder head 1. The fixing of the precombustion chamber module 10 to the cylinder head 1 is achieved by means of the two screws 19, which are guided through the drilled holes 34 (FIG. 8a) of the upper collar of the precombustion chamber module 10. The precombustion chamber injector 33 can be fixed to the precombustion chamber module 10 using a holding clamp 32 which can also be inserted into the drilled hole 30 for receiving the precombustion chamber injector 33. The holding clamp 32 is fixed to the precombustion chamber module 10 by means of the three screws 35, wherein for this purpose corresponding drilled holes 36 arc also provided on the collar (FIG. 8a). Here, reference sign 40 shows a sensor access, in order to be able to install a sensor 41 in the region of the cavity 11, inside the precombustion chamber module 10. The sensor 41 can for example be a sensor for acquiring pressure values and/or temperature values and/or the lambda value within the precombustion chamber.

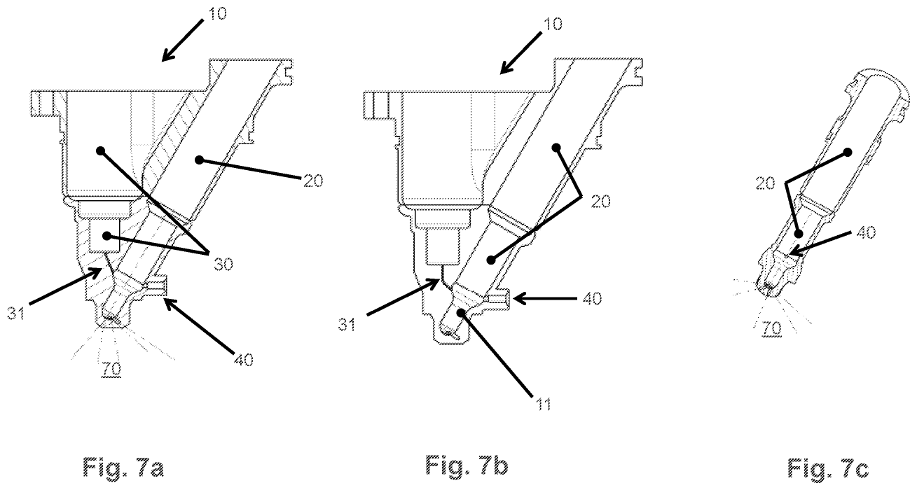

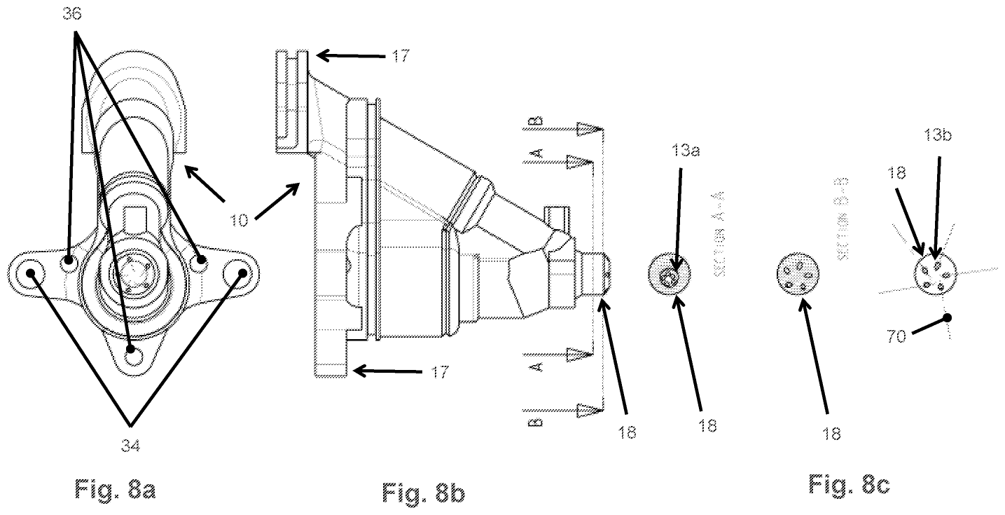

FIG. 7a, 7b show different embodiments of the precombustion chamber module 10, which differ from one another with respect to the channel guidance of the connecting channel 31. In the left-hand view of FIG. 7a, the connecting channel 31 is straight. In the embodiment of FIG. 7b, the connecting channel 31 instead has an angled or curved channel course, wherein the configuration is such that the entire channel course is exposed by a corresponding selected planar cut. Alternatively, to those embodiments shown, the connecting channel can have a helical course. During operation, the helical or coil-shaped channel guidance additionally forces turbulence of the fuel introduced into the cavity 11 forming the precombustion chamber, as a result of which the mixing there with the amount of air present therein can be promoted.

FIG. 7c is a sectional view of the precombustion chamber module 10 along the longitudinal axis 20a, wherein the precombustion chamber module 10 has been rotated about 90° in the clockwise direction, with respect to the orientation present in FIG. 7a, 7b.

The line illustrations 70 indicate the spray pattern of the fuel supplied into the main combustion chamber 7 via the precombustion chamber. Within the main combustion chamber 7, the spray pattern 70 is intended to be optimally symmetrical, which, on account of the orientation of the cavity 11, forming the precombustion chamber, in a manner inclined relative to the main combustion chamber 7 requires in each case an orientation of each of the transfer ports 13 that is individually matched thereto.

This particular orientation of the transfer ports 13 is shown in the sectional views of FIG. 8c. Here, the left-hand illustration has a profile cross-section through the dome 18 in the lower region of the cavity 11. Therefore, the port openings 13a, located close together, inside the cavity 11 are therefore visible. The central illustration is a profile section close to the lower edge of the dome 18, and the right-hand illustration is a view of the underside of the dome 18 which, with respect to an operation-ready installation on a combustion chamber unit or an operation-ready internal combustion engine, is located inside the main combustion chamber 7. It can be seen here that the outlet openings 13b of the transfer ports 13 are arranged on an annular group of the dome 18. This makes it possible for the length of the individual transfer ports 13 to be selected differently, as a result of which the oblique position of the cavity 11 forming the precombustion chamber is compensated, in order to be able to achieve the above-mentioned symmetrical spray pattern inside the main combustion chamber 7.

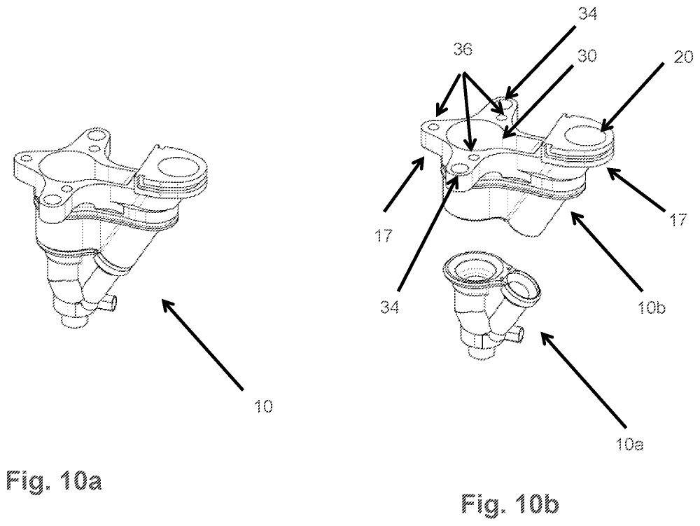

FIG. 9 is a view of the underside of the dome 18, from a perspective inside the main combustion chamber 7. The undersides of the valve lifters 55a, 55b of the intake and exhaust valves 51, 53 are visible. From this perspective, the symmetrical and uniformly distributed arrangement of the openings 13b of the transfer ports 13 on a common annular group is visible, which is decisive for a symmetrical spray pattern 70.

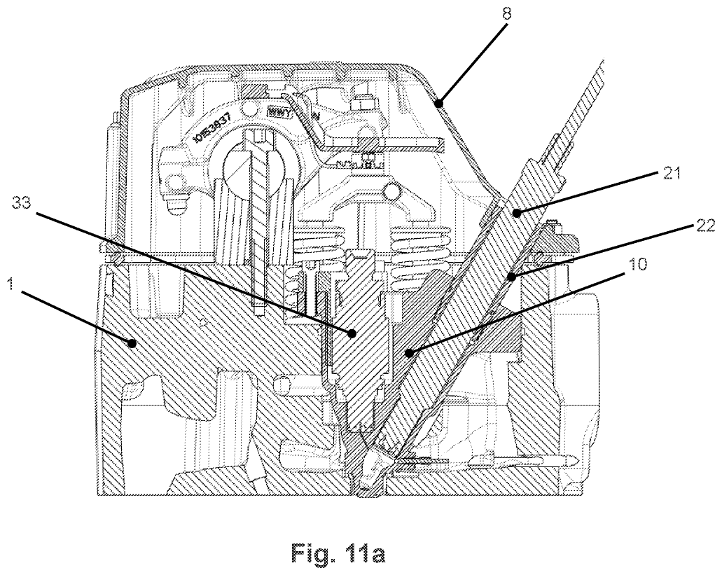

FIG. 10a, 10b explicitly show a multipart embodiment of the precombustion chamber module 10. In this embodiment, the precombustion chamber module 10 is configured at least in two parts and consists of a first component 10a, in which the cavity 11 forming the precombustion chamber, the connecting channel 31, and the transfer ports 13 are contained. The further component 10b comprises merely a majority, in terms of volume, of the recesses 20, 30 for receiving the spark plug 21 and the precombustion chamber injector 33, the contact surfaces 17 for striking against the cylinder head 1, and the drilled holes 34, 36. Since in particular the first component 10a is subject to significantly higher demands on the dimension specifications and the surface quality, the first component 10a is produced according to the disclosure by 3D printing or by means of another additive method, whereas preferably a more cost-effective method is used for manufacturing the further component 10b. It is of course also conceivable that the precombustion chamber module 10 may consist of and be made up from more than two individual parts.

Since in particular the transfer ports 13 are subject to significant wear in engine operation, a replacement may be expedient here for preserving the function of the precombustion chamber. The multipart manufacture makes it possible, for example, to replace only the first component 10a, while the remaining parts can continue to be used.

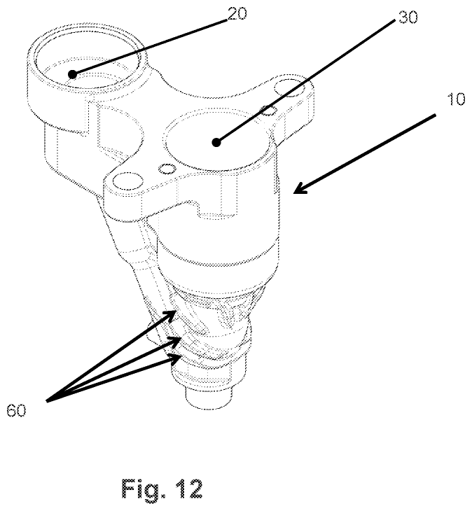

FIG. 12 is a perspective view of the precombustion chamber module 10 which is provided with ribs 60 in the region of the outer surfaces around which a cooling medium flows, in order to thereby achieve greater cooling of the cavity 11 forming the precombustion chamber. The rib-shaped configuration is preferably selected such that it results not only simply in a general surface enlargement, but rather furthermore turbulence, oriented in this way, of the cooling medium flowing around, can be produced, which turbulence locally promotes the dissipation of heat particularly effectively where the cooling is associated with particularly high added value.

As has already been set out repeatedly, the disclosure, explained in detail above, has the advantage that an internal combustion engine of this kind can be operated according to different designs. According to Design I, the active precombustion chamber integrated by means of the precombustion chamber module 10 can perform merely the function of an ignition amplifier. Integration of a suitable precombustion chamber module 10, and the type-appropriate equipping thereof, makes it possible for the internal combustion engine to be operated according to Design II. The main combustion chamber 7 of an internal combustion engine equipped in this way can be supplied with fuel merely via the active precombustion chamber, because no further fuel path is present. If an alternative fuel path to this exists, for example via intake manifold injection, then the internal combustion engine can selectively provide a fuel supply via the active precombustion chamber or alternatively via the second fuel path, for example by means of intake manifold injection. A corresponding embodiment, in which, due to the construction, the main injection for covering the fuel requirement necessary in the main combustion chamber 7 can take place fully along the fuel path extending over the precombustion chamber only within a limited portion of the engine operating range, is possible (Design IIIa). An embodiment is also possible in which, despite the existence of an alternative fuel path (for example via intake manifold injection), the fuel path extending via the precombustion chamber is configured such that the internal combustion engine can obtain a fuel supply exclusively via the precombustion chamber, within its entire speed/torque working range (Design IIIb).

In the case of the last variant, i.e. a combustion chamber unit according to the Design IIIb, in corresponding engine operating situations it is provided, in accordance with the embodiment and as intended, that the active precombustion chamber optionally performs the function of an ignition amplifier, and/or optionally secondary injections can take place via the active precombustion chamber, while the fuel supply that serves for building up the actual engine torque takes place exclusively via the inlet manifold intake, or a first portion of the correspondingly required amount of fuel is supplied via the inlet manifold intake, and a remaining portion via the precombustion chamber. A corresponding operation according to the two last-mentioned variants can also be carried out for a combustion chamber unit configured according to Design IIIa, if the current engine operating point is covered with a correspondingly small supply of fuel which, in terms of amount, can be covered by using only the fuel path extending via the precombustion chamber.

In an advantageous embodiment, a precombustion chamber module (10) according to the disclosure makes it possible to use a structurally identical cylinder head 1, irrespective of whether the finished internal combustion engine is intended to correspond to Design I, II, IIIa or IIIB.

### LIST OF REFERENCE SIGNS

Cylinder head 1
Flame plate 2
Cooling channel 3
Receptacle for precombustion chamber module 4
Air outlet 5
Air intake 6
Main combustion chamber 7
Main combustion chamber longitudinal axis 7a
Cylinder head cover 8
Piston 9
Precombustion chamber module 10
First component of the module 10a
Second component of the module 10b
Cavity 11
Cavity longitudinal axis 11a
Flange ring 12
Transfer ports 13
Openings of the transfer ports 13a
Outlet openings of the transfer ports 13b
Widening 14
Spanned plane of the longitudinal axes of the 15
receptacles 20, 30
Liner 16
Contact surface 17
Precombustion chamber dome 18
Screws for fixing the module to the cylinder head 19
Ignition device receptacle 20
Longitudinal axis of receptacle for ignition device 20a
Spark plug 21
Guide sleeve 22, 22a
Cylinder head seal 23
Receptacle for precombustion chamber injector 30
Longitudinal axis of the receptacle for the 30a precombustion chamber injector
Connecting channel 31
Holding clamp 32
Precombustion chamber injector 33
Drilled holes for screws 19 34
Screws for fixing the holding clamp to the module 35
Drilled holes for screws 35 36
Sensor receptacle 40
Sensor 41
Valve drive 50
Exhaust valves 51
Valve bridge of the exhaust valves 51a
Rocker lever of the exhaust valves 51b
Drilled holes for valve lifter of the exhaust valves 51c
Spanned plane of the drilled holes 51c 51e
Intake valves 53
Valve bridge of the intake valves 53a
Rocker lever of the intake valves 53b
Drilled holes for valve lifter of the intake valves 53c
Spanned plane of the drilled holes 53c 53e
Valve lifter of the exhaust valves 55a
Valve lifter of the intake valves 55b
Cooling ribs 60
Spray pattern 70

1. A method for producing an internal combustion engine, comprising a precombustion chamber and an ignition device that protrudes into the precombustion chamber, and a precombustion chamber injector that supplies fuel to the precombustion chamber, wherein
a precombustion chamber module having an integral cavity, forming the precombustion chamber, is manufactured as a separate component from a cylinder head, wherein the precombustion chamber module comprises, in addition to the integral cavity forming the precombustion chamber, at least one transfer port for fluidic connection between the precombustion chamber and main combustion chamber, and the precombustion chamber module is produced as a whole or at least in part by means of an additive method, by 3D printing.

2. The method according to claim 1, wherein the precombustion chamber module serves as a support for receiving the precombustion chamber injector and/or the ignition device.

3. The method according to claim 2, wherein the precombustion chamber module is equipped with the ignition device and/or the precombustion chamber injector prior to installation into the cylinder head.

4. The method according to claim 2, wherein the precombustion chamber module, equipped with its active components, i.e., the precombustion chamber injector and/or the ignition device, undergoes a function test prior to installation into the cylinder head.

5. The method according to claim 1, wherein the precombustion chamber module is provided with a connecting channel in order to fluidically connect the precombustion chamber injector, inserted into the precombustion chamber module, to the integral cavity.

6. The method according to claim 5, wherein an inside wall of the connecting channel is manufactured having a non-cylindrical contour, preferably a conical contour, at least in portions, preferably within a continuous length portion, wherein a remaining length region is preferably created having a cylindrical contour.

7. The method according to claim 5, wherein the connecting channel is manufactured having a curved course and/or angled course at least in portions, wherein a trajectory over which the curvature extends is preferably in one plane, and/or the connecting channel is manufactured having a helical course in a longitudinal direction, at least in portions.

8. The method according to claim 1, wherein production of the precombustion chamber module takes place by means of combined 3D printing methods, wherein preferably at least one sub-region of the precombustion chamber module is created by at least two different 3D printing methods which are performed in succession, and/or two different sub-regions of the precombustion chamber module, which can overlap or be completely spatially separated, are manufactured by at least two different 3D printing methods, wherein the at least two different 3D printing methods differ from one another in at least one process parameter of the 3D printing method, with respect to material used for coating material and/or with respect to at least one machine parameter, which for example controls a speed of volume application.

9. The method according to claim 8, wherein the precombustion chamber module is produced by a hybrid method, wherein preferably an identical sub-region of the precombustion chamber module is manufactured by means of a 3D printing method and at least one other production method, and/or a first sub-region of the precombustion chamber module is manufactured by a 3D printing method and a second sub-region of the precombustion chamber module is manufactured by means of the at least one other production method, wherein the first and second sub-region overlap or are located spatially separated from one another.

10. The method according to claim 8, wherein after the 3D printing of at least one sub-region of the precombustion chamber module a buffer layer is applied to the printed region, before the sub-region is printed by means of a deviating 3D printing method, and/or after the production of at least one sub-region of the precombustion chamber module by means of another production method, such as a subtractive method, a buffer layer is applied to the finished sub-region of the precombustion chamber module, before the sub-region is subsequently printed using a 3D printing method, wherein application of the buffer layer preferably takes place in each case by means of 3D printing.

11. The method according to claim 6, wherein the precombustion chamber module is manufactured in two parts or in multiple parts, wherein a first component of the precombustion chamber module comprising the integral cavity that forms the precombustion chamber, and the at least one transfer port, as well as preferably the connecting channel, is produced by means of the additive method, while one or more further components of the precombustion chamber module are manufactured by means of another method.

12. The method according to claim 11, wherein the one or more further components of the precombustion chamber module, which comprise neither the cavity forming the precombustion chamber, nor the connecting channel or the at least one transfer port, are produced by means of a subtractive manufacturing method.

13. The method according to claim 11, wherein firstly a main body for the precombustion chamber module or the first component of the precombustion chamber module is prefabricated, which body or component is subsequently finished by means of an additive manufacturing method, wherein preferably the 3D printing is applied directly to the main body of the precombustion chamber module or the first component or a pre-existing region of the precombustion chamber module.

14. The method according to claim 1, wherein the precombustion chamber module is manufactured having receiving drilled holes for the ignition device and the precombustion chamber injector, longitudinal axes of which holes do not extend in parallel with one another and imaginary axis continuations of which intersect with one another, wherein preferably a longitudinal axis of the precombustion chamber injector or a longitudinal axis of the ignition device extends in parallel with, preferably congruently with, a longitudinal axis of the main combustion chamber, in a state when mounted inside the cylinder head.

15. The method according to claim 1, wherein the precombustion chamber module is manufactured having a longitudinal axis of the integral cavity forming the precombustion chamber that is in parallel with the longitudinal axis of a receiving drilled hole for receiving the ignition device.

16. The method according to claim 11, wherein the cylinder head is manufactured as a standard cylinder head which can selectively be equipped with differently designed precombustion chamber modules, depending on a desired fuel supply design of the internal combustion engine, wherein selection of the precombustion chamber module preferably depends on whether the precombustion chamber is intended to be used purely as an ignition amplifier, or as a fuel supply path for direct injection into the main combustion chamber.

17. The method according to claim 11, wherein the cylinder head is configured having one or more cooling channels that guide a coolant, which channels extend around an outside wall of the precombustion chamber module.

18. The method according to claim 17, wherein during manufacture by means of an additive method one or more ribs are formed on the outside wall of the precombustion chamber module or on the outside wall of the first component of the precombustion chamber module.

19. The method according to claim 16, wherein the precombustion chamber module or the first component of the precombustion chamber module having a cavity forming the precombustion chamber is produced by means of the additive method, and the cavity does not have a rotationally symmetrical geometry.

20. An internal combustion engine, produced according to the method according to claim 1, wherein the precombustion chamber serves as an ignition amplifier.

21. An internal combustion engine, produced according to the method according to claim 1, wherein the precombustion chamber injector also serves for supplying fuel into a relevant main combustion chamber via the precombustion chamber, wherein the precombustion chamber injector is preferably configured such that an amount of fuel that can be supplied for partial load operation and/or full load operation can be supplied exclusively via the precombustion chamber.
